(19) United States
(12) Patent Application Publication
(10) Pub. No.: US 2026/0158772 A1
(43) Pub. Date: Jun. 11, 2026

(54) FILM PASTING DEVICE FOR FOLDABLE PHONES

(71) Applicant: NAKAN Co., Ltd., Osaka-shi (JP)

(72) Inventors: Masafumi Nakata, Osaka-shi (JP); Jianhua Fang, Osaka-shi (JP)

(21) Appl. No.: 19/096,068

(22) Filed: Mar. 31, 2025

(30) Foreign Application Priority Data
Dec. 10, 2024 (JP) 2024215011

(51) Int. Cl. B32B 37/00; B32B 37/10; B32B 37/18

(52) U.S. Cl. CPC B32B 37/0046; B32B 37/10; B32B 37/18; B32B 2457/20

(57) ABSTRACT

Disclosed is a protective sheet attaching unit capable of attaching a protective sheet to a screen of a portable electronic device smoothly from an attachment starting side toward an attachment ending side. The protective sheet has an adhesive surface to be attached to the portable electronic device. A release sheet is peelably attached to the adhesive surface of the protective sheet. A positioning sheet is peelably attached to a surface of the protective sheet opposite to the adhesive surface, and includes a first extension portion and a second extension portion. A device support unit includes a device support portion and a sheet support portion. The protective sheet attaching unit adopts a rolling protective sheet-pressing method to apply force to attach uniformly, thus reducing bubble generation.

### CROSS-REFERENCE TO RELATED APPLICATIONS

This patent application claims the benefit and priority of Japanese Patent Application No. 2024215011, filed with the Japanese Patent Office on Dec. 10, 2024, the disclosure of which is incorporated by reference herein in its entirety as part of the present application.

### TECHNICAL FIELD

The disclosure relates to the technical field of protective sheet unit of mobile equipment, in particular to a protective sheet (film) application unit for foldable phones.

### BACKGROUND OF THE INVENTION

The continuous progress of science and technology leads to the emergence of foldable phones and a rapid increase in the market share of the foldable phones, and at the same time, protective sheet attaching of the foldable phones attracts more and more attention. Chinese Utility Model Patent Application No. 202322085879.1, entitled “Film Pasting Device for Foldable Phones”, discloses the structure of a protective sheet application device for foldable phones. This protective sheet application device mainly has the problem that a UTG film is attached to the screen of a mobile phone by means of the pressing force provided by a scraping plate and the use of the scaping plate is affected by the way in which the scraping plate is held by users, the force applied by the users and the inclination of the scraping plate, leading to nonuniform film pasting and generation of bubbles particularly on a folded portion of the mobile phone.

### SUMMARY OF THE INVENTION

To prevent from generating air bubbles between the screen of a portable electronic device and the protective sheet, it is important to apply the protective sheet to the screen of the portable electronic device sequentially from an application starting end on a side where the application of the protective sheet is started toward an application ending end on a side where the application of the protective sheet is ended. When an unintended part of the protective sheet is applied to the screen of the portable electronic device, it may be difficult to prevent the generation of the air bubbles or remove the generated air bubbles even if a roller or the like is used.

The present invention is to provide a protective sheet application unit capable of applying a protective sheet to a screen of a portable electronic device smoothly from an application starting end toward an application ending end.

A protective sheet application unit for a portable electronic device according to the present invention is provided, includes a protective sheet unit and a device support unit. The protective sheet unit includes a protective sheet, a release sheet, and a positioning sheet. The protective sheet has an adhesive surface to be applied to the portable electronic device. The release sheet is peelably applied to the adhesive surface of the protective sheet. The positioning sheet is peelably applied to a surface of the protective sheet opposite to the adhesive surface, and includes a first extension portion and a second extension portion. The first extension portion is configured to extend from an application starting side of the protective sheet. The second extension portion is configured to extend from an application ending side of the protective sheet. The device support unit includes a device support portion and a sheet support portion. The device support portion is configured to support the portable electronic device. The sheet support portion is configured to support the first extension portion and the second extension portion of the positioning sheet. The sheet support portion is configured to support the second extension portion at a position higher than that of the first extension portion, and allow the application ending side of the protective sheet to descend in a case that a downward force is applied to the positioning sheet and the withdrawal sheet is formed in a strip shape, having one end connected to an end of the release sheet and the other end extending to a front side of the device support unit through an elongated hole formed therein.

In this configuration, the sheet support portion supports the second extension portion at a position higher than that of the first extension portion, such that the protective sheet is disposed to be inclined, and a clearance between the protective sheet and the portable electronic device increases toward the application ending side. Therefore, during the application from an application starting side, no unintended part of the protective sheet is applied to the portable electronic device, and the protective sheet can be smoothly applied to the portable electronic device from the application starting side toward the application ending end.

In the protective sheet application unit described above, preferably, the sheet support portion includes a first protrusion that supports the first extension portion and a second protrusion that supports the second extension portion. The first extension portion has a first hole portion through which the first protrusion is inserted, and the second extension portion has a second hole portion through which the second protrusion is inserted. The second hole portion is configured to be continuously connected with a slit-shaped opening, and the second protrusion is configured to be slidable along the slit-shaped opening when a downward force is applied to the positioning sheet.

In the protective sheet application unit described above, preferably, the protective sheet application unit further includes a pressing unit, the pressing unit includes a press roller, a roller support portion, and a handle portion. The press roller has a circumferential surface capable of pressing the protective sheet from a position above the positioning sheet toward the portable electronic device. The roller support portion is configured to rotatably support the press roller, and includes a pair of guide portions arranged on two sides of the press roller. The handle portion is configured to be continuously connected with the roller support portion. The device support unit includes a pair of guide portions arranged on two sides of the device support portion, and the guide portions of the roller support portion are guided by the guide portions of the device support unit to linearly move the press roller.

In the protective sheet application unit described above, preferably, the sheet support portion is configured to support the first extension portion and the second extension portion such that an angle between the protective sheet and an application surface of the portable electronic device at start of application of the protective sheet is 5 to 45 degrees. This inclination angle is preferably maintained within a range of 5 to 45 degrees from the start to the end of application of the protective sheet.

According to the present invention, a protective sheet can be applied to a screen of a portable electronic device smoothly from an application starting side toward an application ending side.

In some embodiments, the device support portion comprises a receiving cavity shaped to securely accommodate the portable electronic device.

In some embodiments, the receiving cavity includes a plurality of support blocks for elevating the portable electronic device, and the height of the support blocks is less than the thickness of the device, allowing a stable fitting.

In some embodiments, the press roller includes a roller shaft and a roller body, the roller body being rotatably supported on the roller shaft, and the roller shaft being fixedly connected to the roller support portion.

In some embodiments, the roller support portion comprises a cross beam with beam ends extending downward on both sides, and the press roller is connected between the beam ends.

In some embodiments, a handle is disposed on the cross beam to facilitate manual pressing of the protective sheet.

In some embodiments, the guide portions of the device support unit comprise elongated guide grooves, and the beam ends of the roller support portion are received in the guide grooves to ensure linear movement.

In some embodiments, the first and second extension portions of the positioning sheet are configured with positioning holes to engage with the first and second protrusions of the sheet support portion.

In some embodiments, the positioning sheet is formed of a transparent material having high light transmittance to allow visual alignment with the display screen of the portable electronic device.

In some embodiments, the second extension portion is formed to deform elastically or plastically under applied force, enabling descent of the application ending side of the protective sheet.

In some embodiments, the angle formed between the protective sheet and the portable electronic device at the beginning of the application is adjustable by changing the height difference between the first and second protrusions of the sheet support portion.

In some embodiments, the positioning sheet, the release sheet, and the withdrawal sheet are each formed of a transparent material with high light transmittance.

In some embodiments, the press roller is made of a material selected from silicon, urethane, or rubber, and is configured to press the protective sheet without damaging the surface of the portable electronic device.

In some embodiments, the guide portions of the roller support portion are arranged on both sides of the press roller in a direction along its rotational axis.

In some embodiments, the guide portions of the device support unit comprise a guide groove and a guide rib for guiding linear movement of the press roller.

In some embodiments, the positioning sheet is inclined such that a clearance between the protective sheet and the portable electronic device increases toward the application ending side.

In some embodiments, the sheet support portion is detachably connected to the device support portion, allowing the sheet support portion to be replaced or adjusted based on the size or model of the portable electronic device.

The disclosure has the following beneficial effects: the film pressing device adopts a rolling film-pressing method to apply force to protective sheet uniformly, thus reducing the generation of bubbles; on the other hand, the withdrawal film is arranged, and after the positioning sheet is fixed, the release sheet is torn down by means of the withdrawal sheet, thus reducing the pollution of dust or other dirt to the UTG sheet.

### BRIEF DESCRIPTION OF DRAWINGS

FIG. 1A is a perspective view showing a schematic configuration of a protective sheet application unit 1 according to an embodiment of the present disclosure.

FIG. 1B is a side view showing a schematic configuration of the protective sheet application unit 1 according to the embodiment of the present disclosure.

FIG. 2A is a perspective top view of a protective sheet unit 2. FIG. 2B is a side view of showing a configuration of the protective sheet unit 2.

FIG. 2C is a perspective bottom view of the protective sheet unit 2.

FIG. 3A is a perspective view showing a configuration of a device support unit 3.

FIG. 3B is a perspective view showing a configuration of a pressing unit 4.

FIG. 4A shows a state after a release sheet 22 is peeled off from a protective sheet 21 by a withdrawal sheet 24.

FIG. 4B shows a state where the vicinity of an application starting side of the protective sheet 21 is pressed by the pressing unit 4.

FIG. 4C shows a state where the vicinity of the center of the protective sheet 21 is pressed by the pressing unit 4.

FIG. 4D shows a state where the vicinity of an application ending side of the protective sheet 21 is pressed by the pressing unit 4.

FIG. 5 a structural diagram of the sheet assembly according to the disclosure.

### DETAILED DESCRIPTION OF THE INVENTION

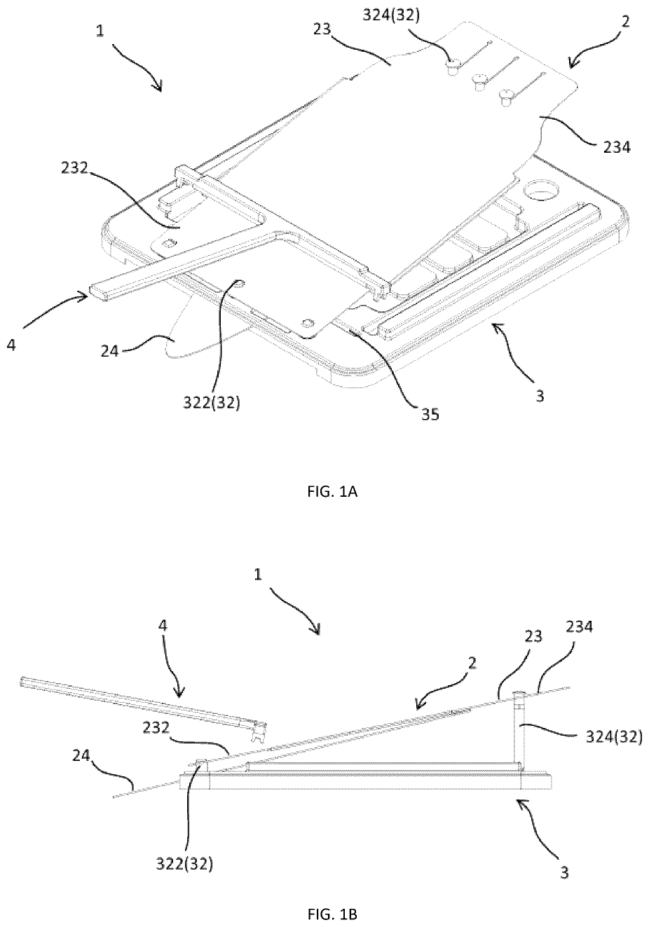

As shown in FIGS. 1A and 1B, the protective sheet application unit 1 for a portable electronic device according to an embodiment includes a protective sheet unit 2, a device support unit 3, and a pressing unit 4. In this embodiment, an example will be described in which a protective sheet 21 is applied to a display screen of a smartphone having a foldable large display screen (about 7 to 10 inches). The protective sheet application unit 1 is configured to support an operation of applying the protective sheet 21 to the smartphone (particularly, a smartphone having a large display screen). However, the portable electronic device to which the present invention is applied is not limited to the smartphone having a large display screen, and the present invention can also be applied to a normal smartphone, a tablet PC, and the like.

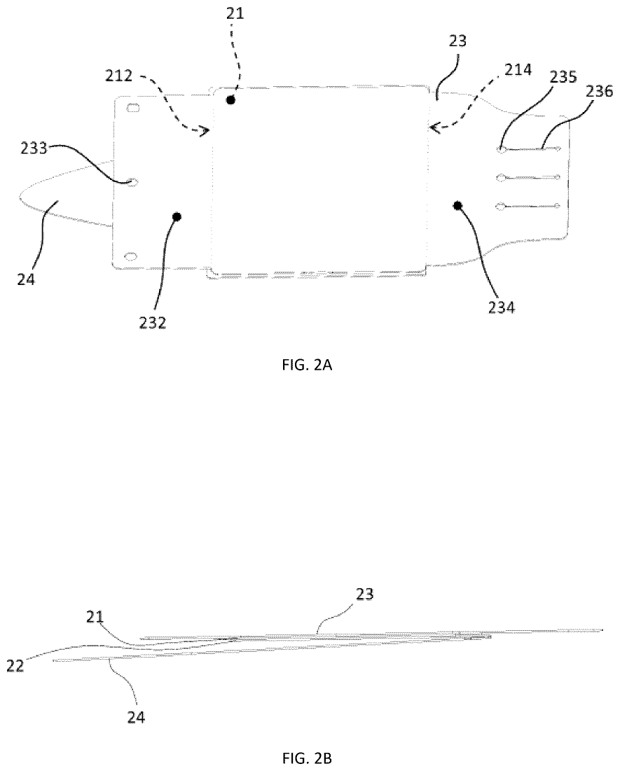

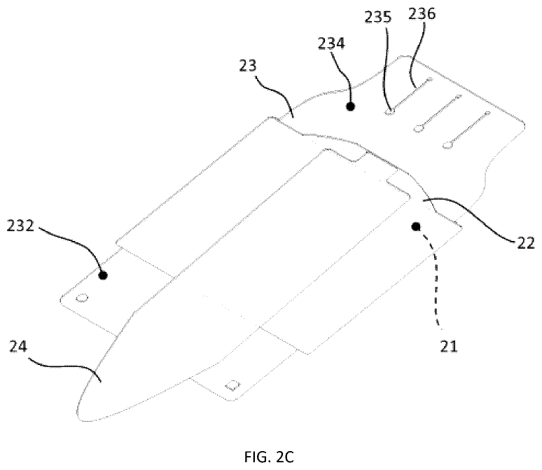

As shown in FIGS. 2A to 2C, the protective sheet unit 2 includes a protective sheet 21, a release sheet 22, a positioning sheet 23, and a withdrawal sheet 24. The protective sheet 21 has an adhesive surface to be applied to the display screen of the smartphone. Examples of the material of the protective sheet 21 include glass, acrylic resin, polyethylene terephthalate resin, and the like. Herein, a glass substrate having a thickness of about 0.03 mm is used as the protective sheet 21. The release sheet 22, the positioning sheet 23, and the withdrawal sheet 24 are preferably formed of a transparent member and have high transparency (transmittance). Examples of the material of the release sheet 22, the positioning sheet 23, and the withdrawal sheet 24 include acrylic resin, polyethylene terephthalate resin, and the like.

The release sheet 22 is peelably applied to the adhesive surface 25 of the protective sheet 21. The positioning sheet 23 is peelably applied to a surface of the protective sheet 21 opposite to the adhesive surface 25.

The positioning sheet 23 includes a first extension portion 232 and a second extension portion 234. The first extension portion 232 is configured to extend from an application starting side 212 of the protective sheet 21 to the outside. The first extension portion 232 has three first hole portions 233. The second extension portion 234 is configured to extend from an application ending side 214 of the protective sheet 21 to the outside. The second extension portion 234 has three second hole portions 235. Each of the second hole portions 235 is configured to be continuously connected with the slit-shaped opening 236. The number of the first hole portions 233 and the number of the second hole portions 235 are not limited to three, and can be adjusted to an appropriate number according to the size of the positioning sheet 23.

The withdrawal sheet 24 is formed in a long belt shape. One end of the withdrawal sheet 24 is connected to an end of the release sheet 22. The other end of the withdrawal sheet 24 passes through an elongated hole 35 of the device support unit 3 and is disposed at a position (for example, a front surface side of the device support unit 3) that is easily gripped by a user. The withdrawal sheet 24 is provided for convenience of peeling the release sheet 22 from the protective sheet 21, and the withdrawal sheet 24 is not particularly necessary in a use form in which the protective sheet unit 2 is set in the device support unit 3 in a state where the release sheet 22 was removed in advance. Therefore, it can be said that the withdrawal sheet 24 has any configuration of the present invention.

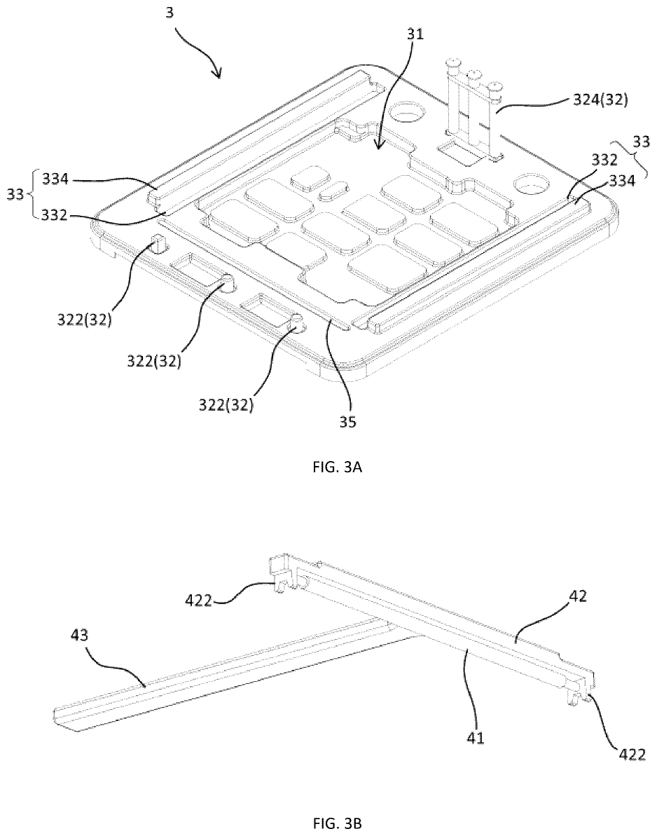

As shown in FIG. 3A, the device support unit 3 includes a device support portion 31 and a sheet support portion 32. The device support portion 31 is configured to support a smartphone by engaging with the smartphone to which the protective sheet 21 is to be applied.

Examples of the materials of the device support unit 3 include polyethylene terephthalate, polyvinyl chloride, polystyrene, polyethylene, polycarbonate, ABS resin (acrylonitrile-butadiene-styrene resin), and the like.

The sheet support portion 32 is configured to support the first extension portion 232 and the second extension portion 234 of the positioning sheet 23. In this embodiment, the sheet support portion 32 includes first protrusions 322 for supporting the first extension portion 232 and second protrusions 324 for supporting the second extension portion 234. The first protrusions 322 are provided toward the device support portion 31, that is, on a front surface side of the device support unit 3. The front surface side of the device support unit 3 is an application starting side. The second protrusions 324 are provided backward the device support portion 31, that is, on a back surface side of the device support unit 3. The back surface side of the device support unit 3 is an application ending side.

The first protrusions 322 and the second protrusions 324 are configured to support the second extension portion 234 at a position higher than that of the first extension portion 232. Specifically, the second protrusions 324 are configured to have a larger height than that of the first protrusions 322. Distal ends of the first protrusions 322 are inserted into the first hole portions 233 of the first extension portion 232, and distal ends of the second protrusions 324 are inserted into the second hole portions 235 of the second extension portion 234. Since the distal ends of the second protrusions 324 are disposed at a position higher than that of the distal ends of the first protrusions 322, the positioning sheet 23 is disposed so as to be inclined from the back surface side toward the front surface side. As a result, at the start of an application, the protective sheet 21 is held by providing a clearance between the protective sheet 21 and the smartphone, which is spread toward an application ending side.

The second hole portions 235 are configured to be continuously connected with the slit-shaped openings 236. The slit-shaped opening 236 is configured to have a width smaller than a diameter of the distal end of the second protrusion 324. Accordingly, when the distal end of the second protrusion 324 enters the slit-shaped opening 236, appropriate frictional resistance is generated between the slit-shaped opening 236 and the second protrusion 324. Therefore, when a downward force is applied to the positioning sheet 23 while the slit-shaped opening 236 lightly holds the second protrusion 324, the distal end of the second protrusion 324 is slidable along the slit-shaped opening 236. As a result, during the operation of applying the protective sheet 21, an application ending side of the protective sheet 21 can descend when the downward force is applied to the positioning sheet 23. However, the configuration in which the application ending side of the protective sheet 21 is lowered as the application proceeds is not limited thereto. For example, instead of the slit-shaped opening 236, it is also possible to adopt a configuration in which the second extension portion 234 is elastically deformed or plastically deformed by an external force.

As shown in FIG. 3B, the pressing unit 4 includes a press roller 41, a roller support portion 42, and a handle portion 43. Examples of the material of the press roller 41 include silicon, urethane, rubber, and the like. Examples of the material of the roller support portion 42 and the handle portion 43 include polyethylene terephthalate, polyvinyl chloride, polystyrene, polyethylene, polycarbonate, ABS resin (acrylonitrile-butadiene-styrene resin), and the like.

The press roller 41 has a circumferential surface capable of pressing the protective sheet 21 from a position above the positioning sheet 23 toward the smartphone. The roller support portion 42 is configured to rotatably support the press roller 41, and includes a pair of guide portions 422 arranged on two sides of the press roller 41. That is, the pair of guide portions 422 sandwiches the press roller 41 in a rotation axis direction of the press roller 41 and are disposed arranged on two sides thereof. The handle portion 43 is configured to be continuously connected with the roller support portion 42. The handle portion 43 is a portion to be gripped by the user when performing an operation of applying the protective sheet 21 to the smartphone.

In the present embodiment, when the protective sheet 21 is applied using the pressing unit 4, a contrivance is made to move the press roller 41 straight from the application starting side toward the application ending side. Specifically, the device support unit 3 described above includes a pair of guide portions 33 arranged on left and right sides of the device support portion 31. The guide portion 33 has a guide groove 332 and a guide rib 334. The press roller 42 can linearly move straight from the application starting side to the application ending side by the guide portions 422 of the roller support portion 42 being guided by the guide portions 33 of the device support unit 3.

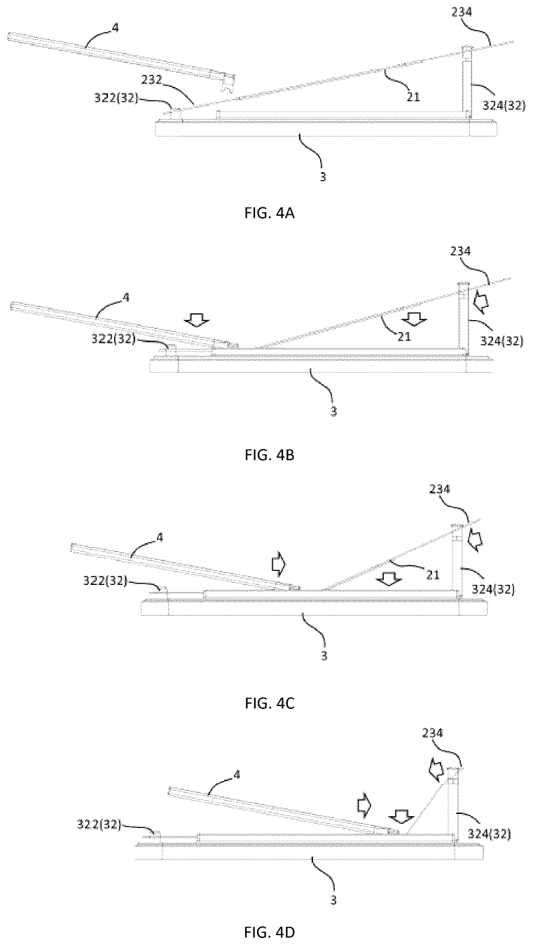

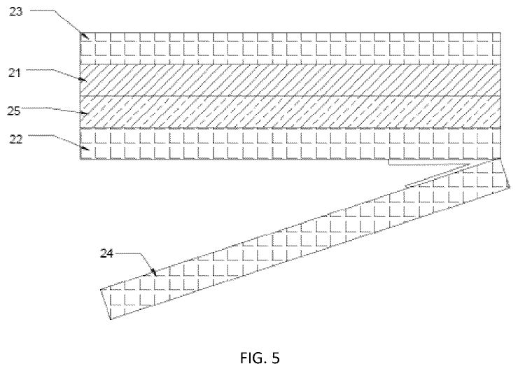

Next, an outline of an operation of applying the protective sheet 21 using the protective sheet application unit 1 will be described with reference to FIGS. 4A to 4D. Before using the protective sheet application unit 1, it is preferable to sufficiently clean a display screen or the like of a smartphone and remove dust, oil stains, and the like. First, the smartphone is fitted into the device support portion 31 of the device support unit 3.

The device support portion 31 of the device support unit 3 is usually designed to have an optimum size for each target smartphone. Therefore, when the smartphone having the suitable size is pushed into the device support portion 31, the smartphone is tightly fitted into the device support portion 31 and is firmly fixed.

Then, the protective sheet unit 2 is set in the device support unit 3 by inserting the first protrusions 322 and the second protrusions 324 into the first hole portions 233 and the second hole portions 235, respectively. After the protective sheet unit 2 is set in the device support unit 3, the release sheet 22 is peeled off by pulling the withdrawal sheet 24.

FIG. 4A shows a state after the release sheet 22 is peeled from the protective sheet 21 by the withdrawal sheet 24. When the release sheet 22 is removed, the adhesive surface 25 of the protective sheet 21 is exposed, and thus the protective sheet 21 can be applied by being pressed against the display screen of the smartphone in this state. As shown in FIG. 4A, preferably, an inclination angle of the protective sheet 21 with respect to the display screen (application surface) of the smartphone at the start of applying the protective sheet 21 is 5 -45 degrees. The inclination angle is, for example, 5 degrees, 10 degrees, 15 degrees, 20 degrees, 25 degrees, 30 degrees, 35 degrees, 40 degrees, or 45 degrees, and may be in a range between any two of these angles (for example, 10 to 15 degrees). When the inclination angle is adjusted, the position and height at which the first extension portion 232 and the second extension portion 234 are supported may be appropriately adjusted by the sheet support portion 32.

FIG. 4B shows a state in which the vicinity of the application starting side 212 of the protective sheet 21 is pressed by the pressing unit 4. In the present embodiment, in a state where the distal ends of the first protrusion 322 are inserted into the first hole portions 233 and the distal ends of the second protrusions 324 are inserted into the second hole portions 235, the position of the application starting side 212 of the protective sheet 21 coincides with an end of the display screen of the smartphone on the application starting side. Therefore, the user can easily perform alignment only by pushing down the positioning sheet 23 using the pressing unit 4. Since a clearance having an appropriate size is formed between the protective sheet 21 and the smartphone and the clearance is configured to increase from the application starting side toward the application ending side, a problem that a part of the protective sheet 21 other than the application starting side 212 is unintentionally applied to the smartphone is less likely to occur.

FIG. 4C shows a state in which the vicinity of the center of the protective sheet 21 is pressed by the pressing unit 4. Since the positioning sheet 23 is pushed down by the pressing unit 4 during the operation of applying the protective sheet 21, the second extension portion 234 is pulled to the application starting side. As a result, the distal ends of the second protrusions 324 enter the slit-shaped openings 236 from the second hole portions 235. By pulling the second extension portion 234 to the application starting side, the distal ends of the second protrusions 324 slide in the slit-shaped openings 236, and the second extension portion 234 moves to the application starting side, and thus the position of the protective sheet 21 descends. Even in this state, a clearance having an appropriate size is formed between the protective sheet 21 and the smartphone and the clearance is configured to increase toward the application ending side, and thus a problem that a part of the protective sheet 21 other than a pressed part is unintentionally applied to the smartphone is less likely to occur.

FIG. 4D shows a state in which the vicinity of the application ending side 214 of the protective sheet 21 is pressed by the pressing unit 4. Until the pressing unit 4 reaches a position above the application ending side 214 of the protective sheet 21, only the pressed part of the protective sheet 21 is always in contact with the smartphone, and an appropriate clearance is maintained on a back side of the pressed portion. Therefore, even when the size of the protective sheet 21 is large, the protective sheet 21 can be suitably applied to the smartphone without generating air bubbles or the like.

As described above, the protective sheet application unit 1 realizes, by a small number of components and a simple configuration, that the protective sheet 21 is held at a suitable position and angle at which the protective sheet 21 is to be easily applied to the smartphone. Accordingly, it is possible to sequentially apply only intended part of the protective sheet 21 to the smartphone, and thus even an unskilled person can succeed in applying the protective sheet 21. Even if air bubbles are generated during the application, the air bubbles can be appropriately removed by the press roller 41.

In the embodiment described above, the pressing unit 4 is used for applying the protective sheet 21, but the protective sheet 21 is always held at a suitable position and angle during the application, and thus a failure is less likely to occur even when the protective sheet 21 is applied using a finger or the like.

The description of the embodiments described above is illustrative in all points and not restrictive. The scope of the present invention is defined by the claims, rather than the embodiments described above. Further, the scope of the present invention is intended to include all modifications within the meaning and scope equivalent to the claims.

In the description of the disclosure, it should be noted that terms such as “center”, “upper”, “lower”, “left”, “right”, “vertical”, “horizontal”, “inner” and “outer” are used to indicate directional or positional relations based on the accompanying drawings merely for the purpose of facilitating and simplifying the description of the disclosure, do not indicate or imply that devices or elements referred to must be in a specific direction or be configured and operated in a specific direction, and thus should not be construed as limitations of the disclosure. In addition, terms “first”, “second” and “third” are merely for the purpose of description, and should not be construed as indicating or implying relative importance.

In the description of the disclosure, it should be noted that unless otherwise expressly stated and defined, terms “mount”, “link” and “connect” should be broadly understood. For example, “connect” may refer to fixed connection, detachable connection, or integrated connection; mechanical connection or electrical connection; direct connection, indirect connection by means of an intermediate medium, or internal connection of two elements. Those ordinarily skilled in the art may appreciate the specific meanings of these terms in the disclosure.

1. A protective sheet application unit for a portable electronic device, comprising:
a protective sheet unit and a device support unit,
wherein the protective sheet unit comprises
a protective sheet having an adhesive surface to be applied to the portable electronic device,
a release sheet peelably applied to the adhesive surface of the protective sheet;
a positioning sheet peelably applied to a surface of the protective sheet opposite to the adhesive surface, the positioning sheet comprising a first extension portion and a second extension portion, the first extension portion is configured to extend from an application starting side of the protective sheet, the second extension portion is configured to extend from an application ending side of the protective sheet, and
a withdrawal sheet formed in a strip shape, having one end connected to an end of the release sheet and the other end passing through an elongated hole formed in a front surface of the device support unit, the elongated hole extending in a longitudinal direction along the front surface, the withdrawal sheet is withdrawable along the front surface in a downward direction to be gripped by a user for manual peeling of the release sheet;
wherein the device support unit further comprises a device support portion and a sheet support portion,
the device support portion is configured to support the portable electronic device,
the sheet support portion is configured to support the first extension portion and the second extension portion of the positioning sheet, the sheet support portion comprising a first protrusion that supports the first extension portion and a second protrusion that supports the second extension portion, the second extension portion at a position higher than a position of the first extension portion to form an angle between the protective sheet and an application surface of the portable electronic device at a start of application;
wherein the second extension portion includes a slit-shaped opening configured to extend toward the portable electronic device, the slit-shaped opening being dimensioned to receive and guide the second protrusion, the second protrusion being slidable within the slit-shaped opening so as to allow movement of the second extension portion toward the portable electronic device during application, thereby allowing the protective sheet to be applied from the application starting side toward the application ending side.

2. The protective sheet application unit according to claim 1, wherein
the first extension portion has a first hole portion through which the first protrusion is inserted, the second extension portion has a second hole portion through which the second protrusion is inserted, and the second hole portion is configured to be continuously connected with the slit-shaped opening.

3. The protective sheet application unit according to claim 1, further comprising a pressing unit, wherein
the pressing unit comprises a press roller, a roller support portion, and a handle portion,
the press roller has a circumferential surface capable of pressing the protective sheet from a position above the positioning sheet toward the portable electronic device,
the roller support portion is configured to rotatably support the press roller, and comprises a pair of guide portions arranged on two sides of the press roller,
the handle portion is configured to be continuously connected with the roller support portion,
the device support unit comprises a pair of guide portions arranged on two sides of the device support portion, and
the guide portions of the roller support portion are guided by the guide portions of the device support unit to linearly move the press roller.

4. The protective sheet application unit according to claim 1, wherein the sheet support portion is configured to support the first extension portion and the second extension portion, whereby the angle between the protective sheet and an application surface of the portable electronic device at start of application of the protective sheet is 5 to 45 degrees.

5. The protective sheet application unit according to claim 1, wherein the device support portion comprises a receiving cavity shaped to securely accommodate the portable electronic device.

6. The protective sheet application unit according to claim 5, wherein the receiving cavity includes a plurality of support blocks for elevating the portable electronic device, and the height of the support blocks is less than the thickness of the device, allowing a stable fitting.

7. The protective sheet application unit according to claim 3, wherein the press roller includes a roller shaft and a roller body, the roller body being rotatably supported on the roller shaft, and the roller shaft being fixedly connected to the roller support portion.

8. The protective sheet application unit according to claim 3, wherein the roller support portion comprises a cross beam with beam ends extending downward on both sides, and the press roller is connected between the beam ends.

9. The protective sheet application unit according to claim 8, wherein a handle is disposed on the cross beam to facilitate manual pressing of the protective sheet.

10. The protective sheet application unit according to claim 3, wherein the guide portions of the device support unit comprise elongated guide grooves, and the beam ends of the roller support portion are received in the guide grooves to ensure linear movement.

11. The protective sheet application unit according to claim 1, wherein first and second extension portions of the positioning sheet are configured with positioning holes to engage with the first and second protrusions of the sheet support portion.

12. The protective sheet application unit according to claim 1, wherein the positioning sheet is formed of a transparent material having high light transmittance to allow visual alignment with a display screen of the portable electronic device.

13. The protective sheet application unit according to claim 1, wherein the second extension portion is formed to deform elastically or plastically under applied force, enabling descent of the application ending side of the protective sheet.

14. The protective sheet application unit according to claim 4, wherein the angle formed between the protective sheet and the portable electronic device at the beginning of the application is adjustable by changing the height difference between the first and second protrusions of the sheet support portion.

15. The protective sheet application unit according to claim 1, wherein the positioning sheet, the release sheet, and the withdrawal sheet are each formed of a transparent material with high light transmittance.

16. The protective sheet application unit according to claim 3, wherein the press roller is made of a material selected from silicon, urethane, or rubber, and is configured to press the protective sheet without damaging the surface of the portable electronic device.

17. The protective sheet application unit according to claim 3, wherein the guide portions of the roller support portion are arranged on both sides of the press roller in a direction along its rotational axis.

18. The protective sheet application unit according to claim 3, wherein the guide portions of the device support unit comprise a guide groove and a guide rib for guiding linear movement of the press roller.

19. The protective sheet application unit according to claim 1, wherein the positioning sheet is inclined such that a clearance between the protective sheet and the portable electronic device increases toward the application ending side.

20. The protective sheet application unit according to claim 1, wherein the sheet support portion is detachably connected to the device support portion, allowing the sheet support portion to be replaced or adjusted based on the size or model of the portable electronic device.
